(19) United States
(12) Patent Application Publication
(10) Pub. No.: US 2007/0262552 A1
(43) Pub. Date: Nov. 15, 2007

(54) Suspension system for a transport vehicle

(76) Inventors: Earl Sutton, Chino, CA (US); James R. McGhie, Henderson, NV (US)

Correspondence Address: JOHN S. CHRISTOPHER, 6033 WEST CENTURY BOULEVARD, SUITE #400, LOS ANGELES, CA, 90045-6416, US

(21) Appl. No.: 11/800,361

(22) Filed: May 5, 2007

Related U.S. Application Data
(63) Continuation-in-part of application No. 11/185,417, filed on Jul. 20, 2005, now Pat. No. 7,213,824.

(51) Int. Cl. B60G 9/00

(52) U.S. Cl. 280/124.157

(57) ABSTRACT

A multi-axle transport vehicle for hauling heavy loads including a plurality of modules in mechanical communication mounted on axles and wheels and being driven by a first prime mover and a draw bar, the modules including forward, center and rear modules, an automatic steering unit cooperating with the draw bar and having a hydraulic control unit and a plurality of push-pull pistons and steering rods for controlling axle and wheel position, a central spine formed on the forward module and carrying a forward bearing for providing structural support for a transported load mounted on the center module, a suspension system including first and second arms attached to an axle linkage member and cooperating with first and second fluid activated cylinders attached to the modules for dynamically suspending the transported load, and a bearing positioned on the rear module for providing structural support to the transported load.

### CROSS REFERENCE TO RELATED APPLICATION

This patent application is a continuation-in-part application under 37 C.F.R. Section 1.53(b)(2) of co-pending patent application having Ser. No. 11/185,417 filed Jul. 20, 2005, and claims the filing benefit under 35 U.S.C. Section 119(e) of U.S. Provisional Patent Application No. 60/383,554 filed May 24, 2002, each of which is incorporated herein by reference.

### BACKGROUND OF THE INVENTION

1. Technical Field

The present invention pertains generally to multi-axle transport vehicles for moving heavy loads, and more particularly to a suspension system for such vehicles.

2. Background Art

Heavy hauling vehicles for moving transformers, cranes, boats, industrial equipment, and other heavy objects are well known in the art. An example of such a vehicle is disclosed in U.S. Pat. No. 4,943,078 which discloses a heavy load hauler for traveling on conventional roadways for moving heavy construction equipment such as cranes or the like from one work site to another. The hauler includes a front tractor drawn carriage, a rear carriage, and a load unit disposed between and carried by the carriages. The front carriage is supported upon a multiplicity of independent wheel and axle units. There is a first fifth wheel coupling at the leading edge of the front carriage for connecting to the fifth wheel coupling of a tractor. A second fifth wheel coupling is spaced rearwardly on the front carriage.

The load carrying rear carriage is also supported upon a multiplicity of independent wheel and axle units. There is a fifth wheel coupling intermediate the leading and trailing edges of the rear carriage. The load unit has forwardly and rearwardly projecting goosenecks. Each gooseneck has a fifth wheel coupling. The fifth wheel coupling located on the forwardly projecting gooseneck connects to the fifth wheel coupling on the front carriage. The fifth wheel coupling located on the rearwardly projecting gooseneck connects to the fifth wheel coupling on the rear carriage. The load unit may be either the crane itself or a flatbed upon which the crane is carried. At least some of the independent wheel and axle units are steerably mounted on their carriages. Each wheel and axle unit has its wheels supported by a hydraulic suspension. Hydraulic circuitry interconnects all of the suspensions so as to equally distribute the load among all of the wheel units. Steering of the independent wheel and axle units is interphased for the front and rear carriages by a pair of operatively associated interrelated in-line valve cylinder units. FIG. 12A of U.S. Pat. No. 4,943,078 shows a valve 718 used in a power steering system which is coupled to a connecting link 703.

Other heavy hauling vehicles are sold by Goldhofer Fahrzeugwerk G.m.b.H. of Memmingen, Germany; Nicolas of Champs Sur Yonne, France; and Talbert of Rensselaer, Ind.

Improved systems having automatic steering at all speeds and suspension systems that respond rapidly to the varying road conditions imposed by higher speeds would greatly reduce the time and effort required to move the vehicle to the load, move the load, and return the vehicle to storage.

### DISCLOSURE OF THE INVENTION

The present invention is directed to a suspension system for a heavy load transport vehicle which tends to resist axle yaw. The body of the suspension system is connected to the axle by an axle linkage member which is connected to the body at four different pivotal locations. This four-point connection stabilizes the axle linkage member and substantially reduces any tendency to yaw when exposed to road induced forces. The suspension system employs two fluid activated cylinders rather than the conventional one cylinder. This feature allows the use of smaller diameter cylinders for a given system pressure. The cylinders are mounted on the outside of the suspension system for ease of maintenance.

In accordance with a preferred embodiment of the invention, a suspension system for a transport vehicle includes a body which is pivotable about a first axis, the body having a first attachment station separate and spaced apart from a second attachment station. An axle is disposable along a second axis which is perpendicular to the first axis. An axle linkage member has a third attachment station which is spaced apart from a fourth attachment station. The third attachment station of the axle linkage member is pivotally connected to the first attachment station of the body, and the fourth attachment station of the axle linkage member is pivotally connected to the second attachment station of the body. The axle linkage member is pivotable about a third axis which is parallel to the second axis. The axle is pivotally connected to the axle linkage member and the axle is pivotable about a fourth axis which is perpendicular to the first, second and third axes. Two separate and spaced apart fluid activated cylinders are pivotally connected between the body and the axle linkage member, wherein the two fluid activated cylinders are disposed outside of the first, second, third, and fourth attachment stations. When the two fluid activated cylinders are extended, the axle linkage member pivots away from the body. When the two fluid activated cylinders are retracted, the axle linkage member pivots towards the body.

In accordance with an aspect of the invention, when the transport vehicle is traveling on a road, the connection of the first attachment station to the third attachment station, the connection of the second attachment station to the fourth attachment station, and the connection of the two fluid activated cylinders between the body and the axle linkage member combine to reduce yaw of the axle.

Other aspects of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a side elevation view of a prior art multi-axle transport vehicle for moving heavy loads;

FIG. 2 is a top plan view of the vehicle of FIG. 1;

FIG. 3 is a front elevation view of a prior art axle suspension system;

FIG. 4 is a side elevation view of the prior art suspension system;

FIG. 5 is a front elevation view of a suspension system in accordance with the present invention;

FIG. 6 is a side elevation view of the suspension system of the present invention;

FIG. 7 is a rear elevation view of the suspension system of the present invention;

FIG. 8 is a front elevation view of the suspension system of the present invention with an axle rotated in a clockwise direction;

FIG. 9 is a front elevation view of the suspension system of the present invention with the axle rotated in a counter-clockwise direction;

FIG. 10 is a side elevation view of the suspension system of the present invention in a fully retracted position;

FIG. 11 is a side elevation view of the suspension system of the present invention in a mid-stroke position;

FIG. 12 is a side elevation view of the suspension system of the present invention in a fully extended position;

FIG. 13 is a side elevation view of the suspension system of the present invention when the tires encounter a pothole;

FIG. 14 is a side elevation view of the suspension system of the present invention when the tires encounter a bump;

FIG. 15 is a simplified bottom plan view of a prior art axle linkage member;

FIG. 16 is a simplified bottom plan view of the axle linkage member of the suspension system of the present invention;

FIG. 17 is a perspective view of a tractor vehicle showing a draw bar used to tow the multi-axle transport vehicle of the present invention;

FIG. 18 is a perspective view of the tractor draw bar connecting to the forward module of the transport vehicle and showing an automatic power steering unit;

FIG. 19 is a perspective view showing the structure of the automatic power steering unit of the forward module of the transport vehicle;

FIG. 20 is a perspective view of the rear portion of the forward module of the transport vehicle showing a front main bearing mounted on a central spine of the forward module for point loading;

FIG. 21 is an alternative perspective view of the rear portion of the forward module of the transport vehicle showing the front main bearing mounted on the central spine of the forward module for point loading;

FIG. 22 is a perspective view of the froward module of the transport vehicle showing the hydraulic suspension system;

FIG. 23 is a perspective view of the center module of the transport vehicle showing the load bearing payload section of the present invention;

FIG. 24 is an alternative perspective view of the center module of the transport vehicle showing the load bearing payload section of the present invention;

FIG. 25 is a perspective view of the rear bearing positioned on the rear module for point loading of the load bearing payload section of the central module;

FIG. 26 is a perspective view of twin steering cabs mounted on the rear module of the transport vehicle for controlling and steering the rear module; and

FIG. 27 is a perspective view of the rear twin driver tractors employed to drive multi-axle the transport vehicle of the present invention.

### DETAILED DESCRIPTION OF THE INVENTION

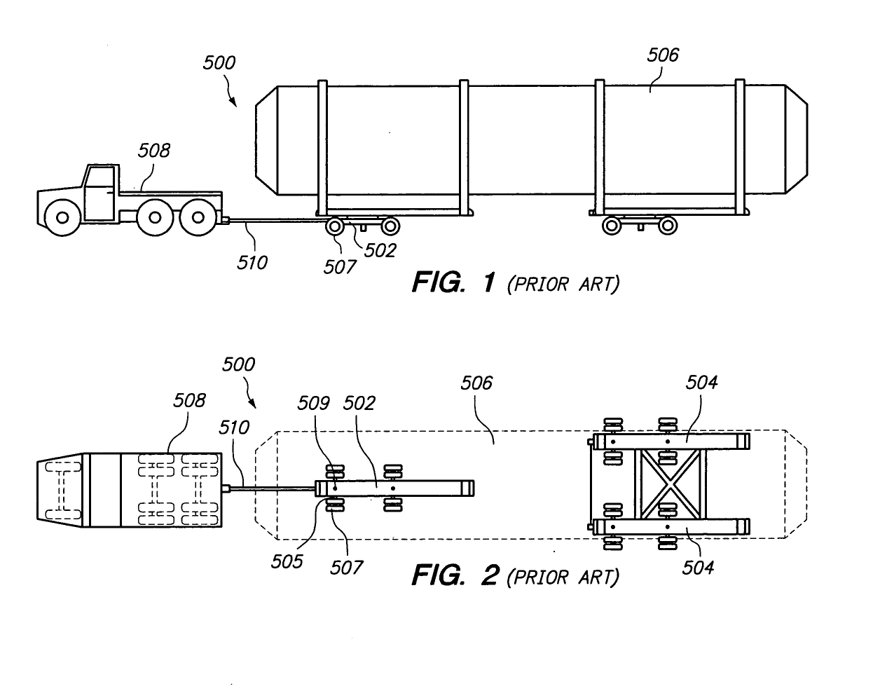

FIGS. 1 and 2 illustrate side elevation and top plan views, respectively, of a prior art multi-axle transport vehicle 500 for moving heavy loads. The vehicle 500 has a front dolly 502 and a pair of rear dollies 504 upon which a load 506 rests. The front dolly 502 and rear dollies 504 each have two axles 505 each with four tires 507. Axles 505 are rotatable about a vertical pivot axis 509 thereby allowing the axles 505 and tires 507 to turn to the right or left. The axles 507 are connected to the frames of the dollies 502, 504 by a suspension system which controls the vertical movement of the axles 505. A towing vehicle 508 such as a tractor pulls transport vehicle 500 using a tow bar 510.

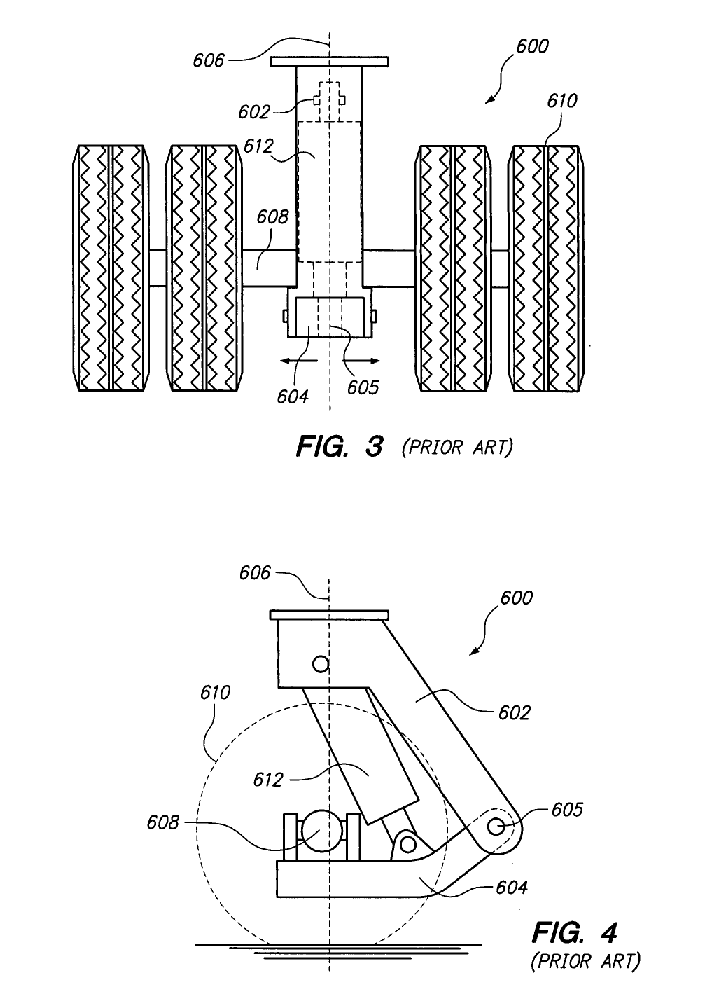

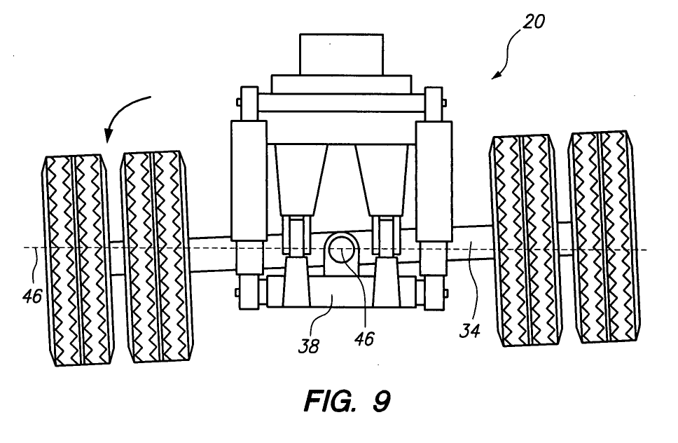

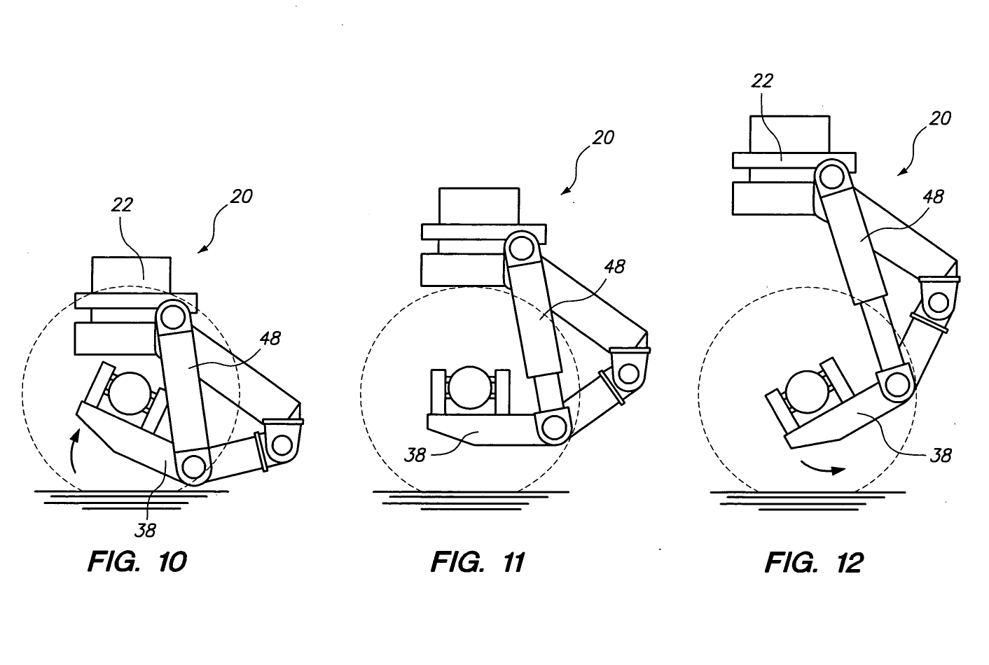

FIGS. 3 and 4 illustrate front elevation and side elevation views, respectively, of a prior art axle suspension system 600. Suspension system 600 includes an upper body 602 which is pivotally connected to an axle linkage member 604 at point 605. Body 602 is connected to the underside of a dolly and pivots about vertical axis 606 thereby permitting the suspension system 600 to turn. An axle 608 and associated tires 610 are connected to axle linkage member 604 thereby permitting axle 608 to roll in response to the road environment (also refer to FIGS. 8 and 9). A single fluid activated cylinder 612 is pivotally connected between body 602 and axle linkage member 604. Fluid activated cylinder 612 usually operates using a combined hydraulic and nitrogen gas system which is well known in the art. When cylinder 612 is extended, axle linkage member 604 pivots away from body 602 raising the top of the dolly further off of the ground (refer to FIG. 12). When cylinder 612 is retracted, axle linkage member 604 pivots toward body 602 lowering the top of the dolly closer to the ground (refer to FIG. 10). In typical operation when the transport vehicle is traveling down a highway, the height of the suspension system 600 is set to a mid-position by appropriately activating cylinder 612. When the transport vehicle goes over an obstacle such as a large bump or a crest of a hill, suspension system 600 is extended to raise the transport vehicle and thereby prevent possible dragging. Conversely, when the transport vehicle goes under an obstruction such as an overpass, suspension system 600 is retracted to lower the transport vehicle and thereby prevent possible collision with the overpass.

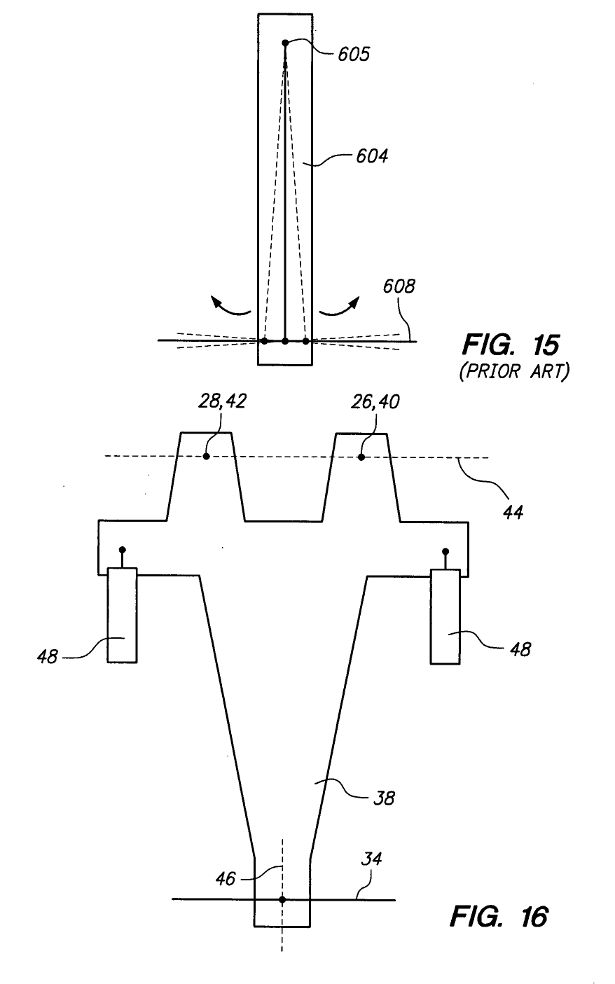

Because axle linkage member 604 is connected to body 602 at only one point 605, the stresses encountered during travel can cause axle linkage member 604 and therefore axle 608 to yaw (refer also to FIG. 15 and the discussion pertaining thereto).

Suspension system 600 is typically designed as a split system so that dollies on the right side of the transport vehicle can be raised and lowered independently from the dollies on the left side of the vehicle.

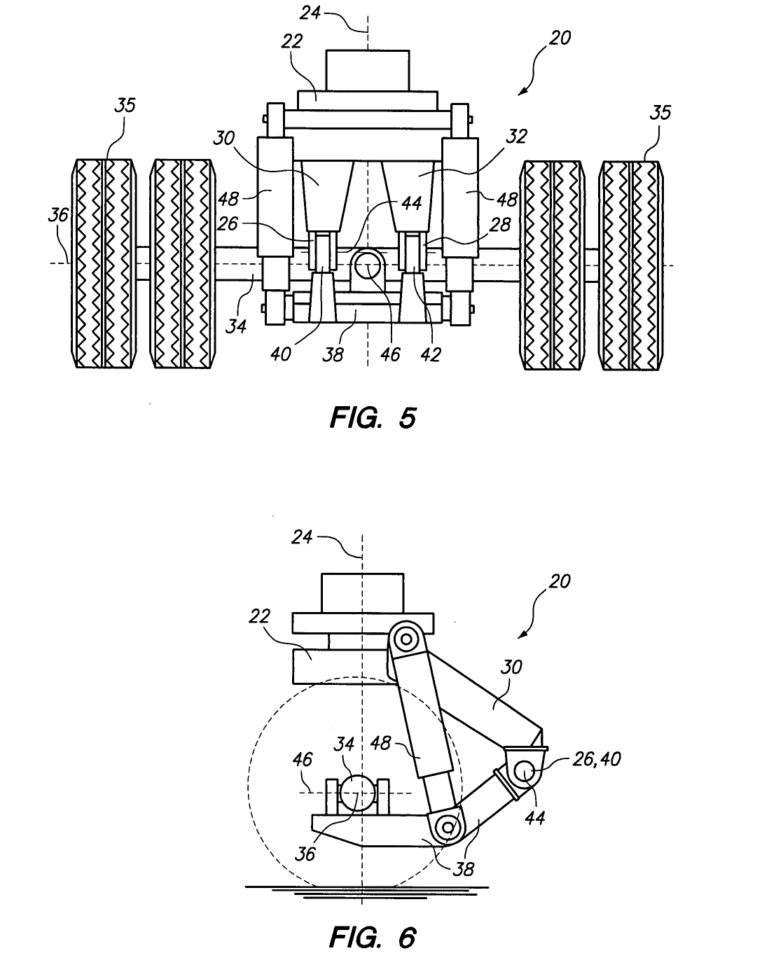

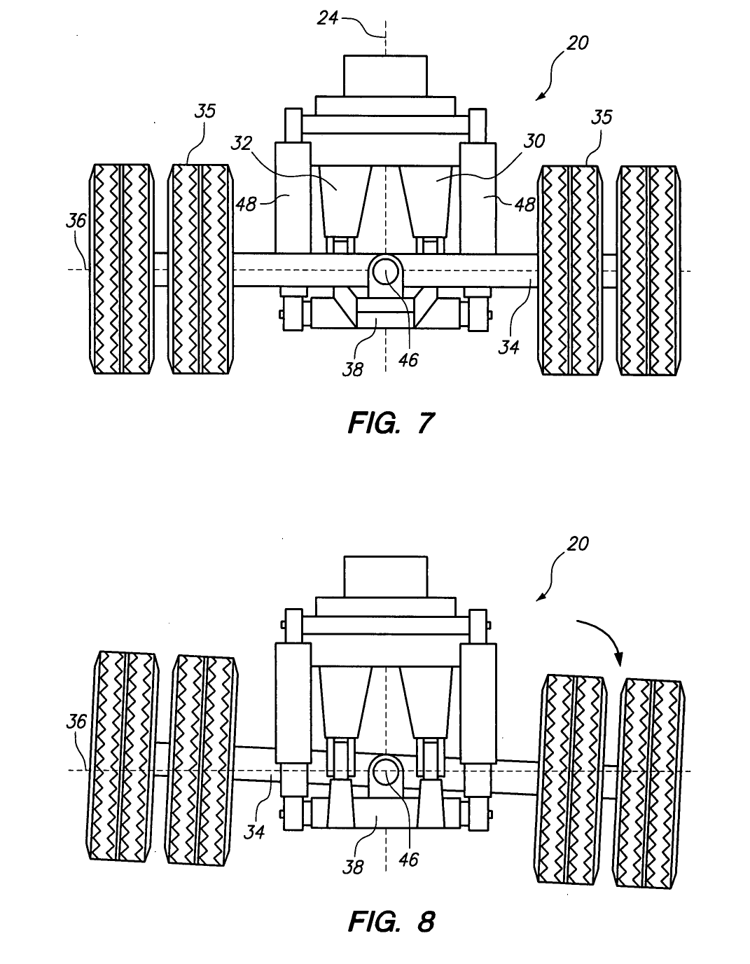

FIGS. 5-7 illustrate front, side and rear elevation views, respectively, of a suspension system for a transport vehicle in accordance with the present invention, generally designated as 20. Suspension system 20 includes a body 22 which is pivotable about a first nominally vertical axis 24. Body 22 further includes a first attachment station 26 spaced apart from a second attachment station 28. In the embodiment shown, body 22 includes first arm 30 and second arm 32 having distal ends upon which the first attachment station 26 and the second attachment station 28 are respectively disposed.

An axle 34 is disposable along a second axis 36 which is perpendicular to first axis 24. Axle 34 is nominally aligned with the second axis 36. However, axle 34 can pivot or roll with respect to second axis 36 as a function of the road surface (also refer to FIGS. 8 and 9). Axle 34 includes tires 35 disposed at its two ends.

An axle linkage member 38 has a third attachment station 40 spaced apart from a fourth attachment station 42. Third attachment station 40 of axle linkage member 38 is pivotally connected to first attachment station 26 of body 22, and fourth attachment station 42 of axle linkage member 38 is pivotally connected to second attachment station 28 of body 22. Axle linkage member 38 is pivotable about a third axis 44 which is parallel to second axis 36.

Axle 34 is pivotally connected to axle linkage member 38 and is pivotable about a fourth axis 46 which is perpendicular to first axis 24, second axis 36, and third axis 44 (refer also to FIGS. 8 and 9).

At least one fluid activated cylinder 48 is pivotally connected between body 22 and axle linkage member 38. Preferably, two spaced apart fluid activated cylinders 48 are pivotally connected between body 22 and axle linkage member 38. The two fluid cylinders 48 are disposed outside of first, second, third, and fourth attachment stations 26, 28, 40, and 42. As defined herein, “outside” means that cylinders 48 reside closer to the tires 35 than the four attachment stations 26, 28, 40, and 42, and that the two cylinders 48 are therefore spaced wider apart than the two pairs of attachment stations.

FIG. 8 is a front elevation view of suspension system 20 with axle 34 rotated about axis 46 in a clockwise direction. FIG. 9 is a front elevation view of suspension system 20 with axle 34 rotated about axis 46 in a counter-clockwise direction. Such positions would result from traveling upon an inclined or crowned road surface.

FIGS. 10-12 are side elevation views of suspension system 20 in fully retracted, mid-stroke, and fully extended positions, respectively. In FIG. 10, the two fluid activated cylinders 48 are retracted causing axle linkage member 38 to pivot toward body 22 thereby lowering the transport vehicle. In FIG. 11, the two fluid activated cylinders 48 are in a mid-stroke position such as would be useful in traveling down a road under normal conditions. In FIG. 12, the two fluid activated cylinders 48 are extended causing axle linkage member 38 to pivot away from body 22 thereby raising the transport vehicle.

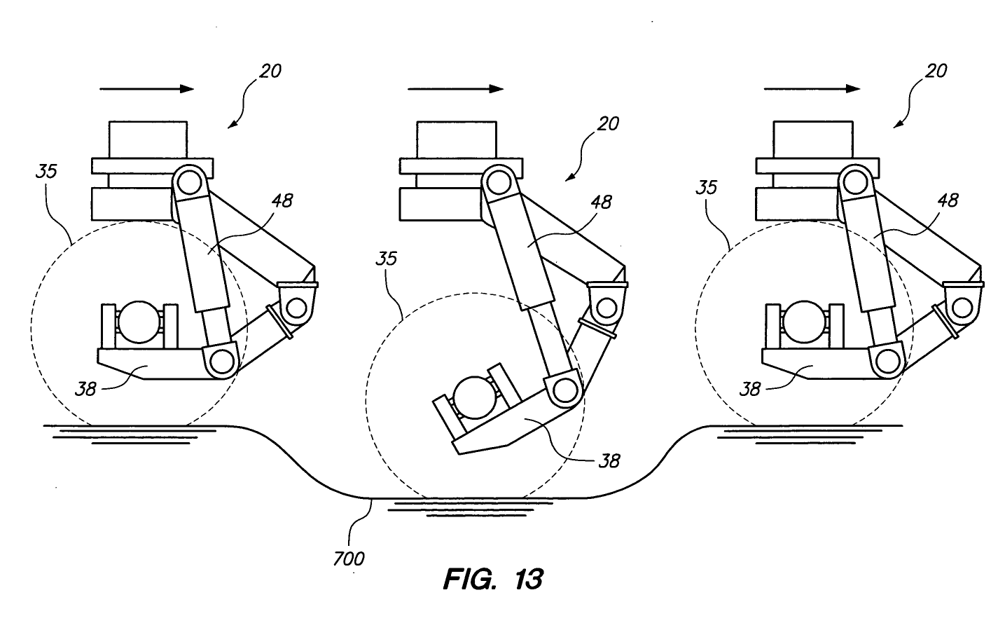

FIG. 13 is a side elevation view of suspension system 20 traveling along a road. When the tires 35 encounter a pothole 700, suspension system 20 automatically extends from a mid-stroke position on the left side view to an extended position in the middle view, and returns to a mid-stroke position on the right side view, thereby cushioning the ride of the transport vehicle.

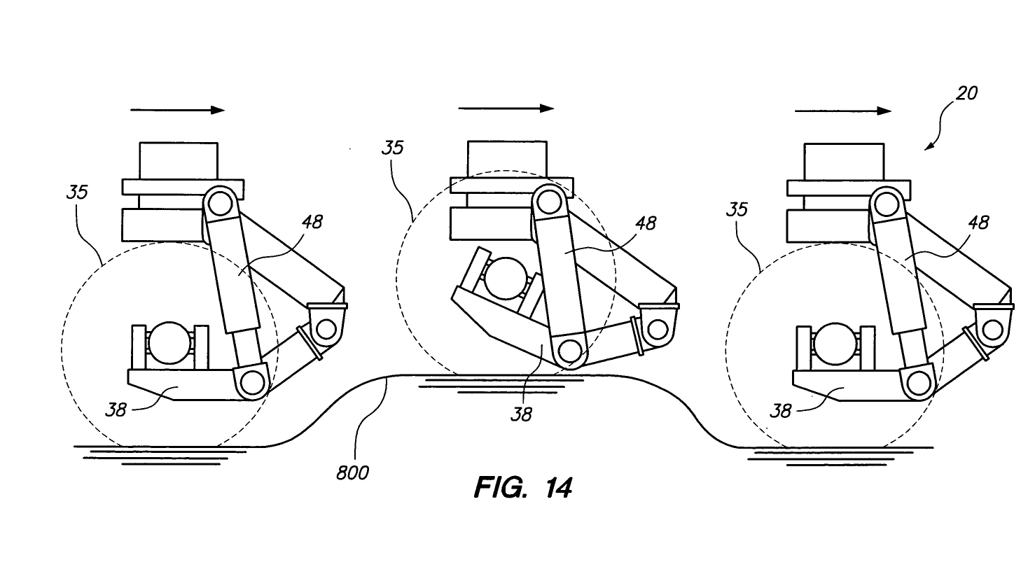

FIG. 14 is another side elevation view of suspension system 20 traveling along a road. When the tires 35 encounter a bump 800, suspension system 20 again automatically cushions the ride of the transport vehicle. In this case, the suspension retracts from a mid-stroke position shown in the left view to a retracted position shown in the middle view, and then returns to the mid-stroke position shown in the right view.

FIG. 15 is a simplified bottom plan view of the prior art axle linkage member 604 of FIGS. 3 and 4 which is pivotally connected to axle 608. Since axle linkage member 604 is only connected to body 602 at a single point 605, forces experienced during driving such as by turning, driving on an incline, traveling over bumps, traveling over potholes, etc. can cause axle linkage member 604 and axle 608 to yaw or rotate horizontally as indicated by the dotted lines so that the axle 608 is no longer perpendicular to the direction of travel. This condition can cause unwanted mechanical stresses and/or vibration, particularly at high speeds.

FIG. 16 is a simplified bottom plan view of axle linkage member 38 of the present invention. In suspension system 20, axle linkage member 38 is not just connected to body 22 at one point (see FIGS. 5-7). Rather, axle linkage member 38 has four attachment points to body 22 including (1) the left side fluid activated cylinder 48, (2) attachment stations 28 and 42, (3) attachment stations 26 and 40, and (4) the right side fluid activated cylinder 48. As a result of the four attachment points, axle linkage member 38 is rigidly locked in place with respect to body 22 and will therefore resist the tendency to yaw. Axle 34 is therefore always substantially perpendicular to the direction of travel. In other words, when the transport vehicle is traveling on a road, the connection of first attachment station 26 to third attachment station 40, connection of second attachment station 28 to fourth attachment station 42, and connection of the two fluid activated cylinders 48 between body 22 and axle linkage member 38 combine to reduce the yaw of axle 34.

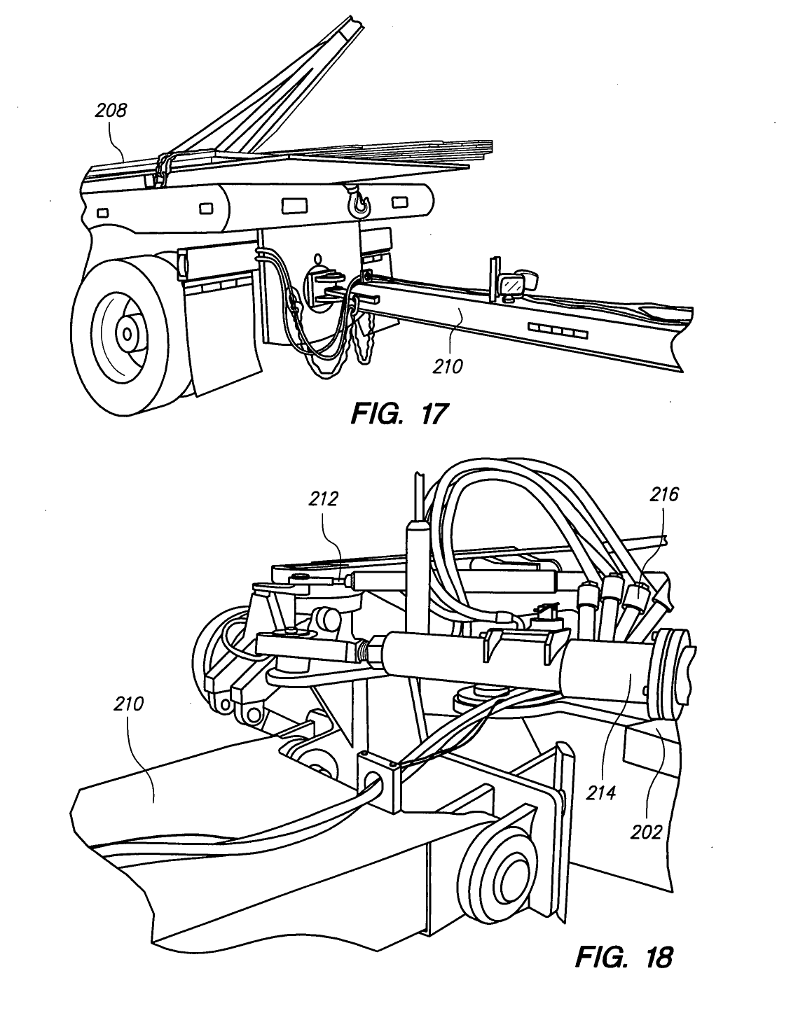

Additional features of the multi-axle transport vehicle for hauling heavy loads will now be discussed. Reference to illustrations of the multi-axle transport vehicle are disclosed in FIGS. 17-27 enclosed herewith.

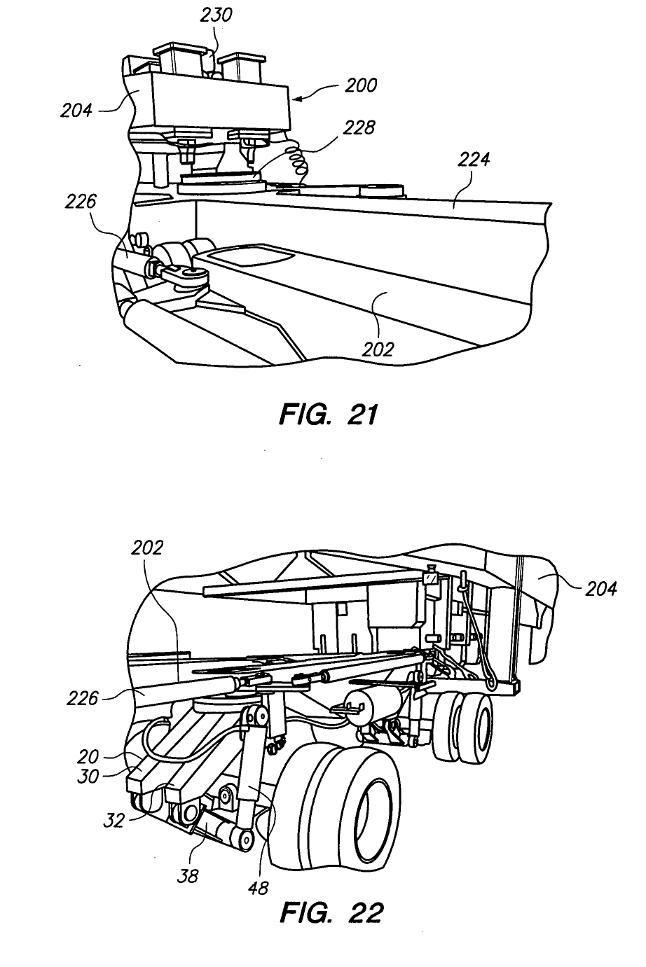

The multi-axle transport vehicle 200 is shown collectively in FIGS. 21-26 and is typically comprised of a forward module 202, center module 204, and a rear module 206. The transport vehicle 200 serves to move heavy loads such as large electrical utility company transformers weighing as much as five-hundred thousand pounds on public roadways while meeting the requirements of local and state regulations. Each of the three modules 202, 204 and 206 are in mechanical communication, that is, they are connected to one another in tandem. The force employed to actually move the forward, center and rear modules 202, 204 and 206, respectively, is typically provided by first and second prime movers.

The first prime mover 208 is shown in FIG. 17 and can include a heavy duty truck or tractor vehicle employed for moving, typically pulling the forward module 202 by employing a draw bar 210. The draw bar 210 is shown attached to the rear section of the first prime mover 208 in FIG. 17 and is shown attached to the front end of the forward module 202 in FIG. 18. The draw bar 210 serves to provide pulling force and provide steering control to the forward module 202. The forward module 202 includes several mechanical subsystems that are significant to the operation of the multi-axle transport vehicle 200 of the present invention. One of those subsystems includes an automatic power steering subsystem 212 that is shown best in FIGS. 18, 19 and 20. In FIG. 18, a forward strut 214 is shown with a hydraulic control unit 216 positioned behind the forward strut 214. The hydraulic control unit 216 controls the flow of the hydraulic fluid to a plurality of push-pull pistons 218 and V-shaped steering rods 220 as a function of the position of the draw bar 210.

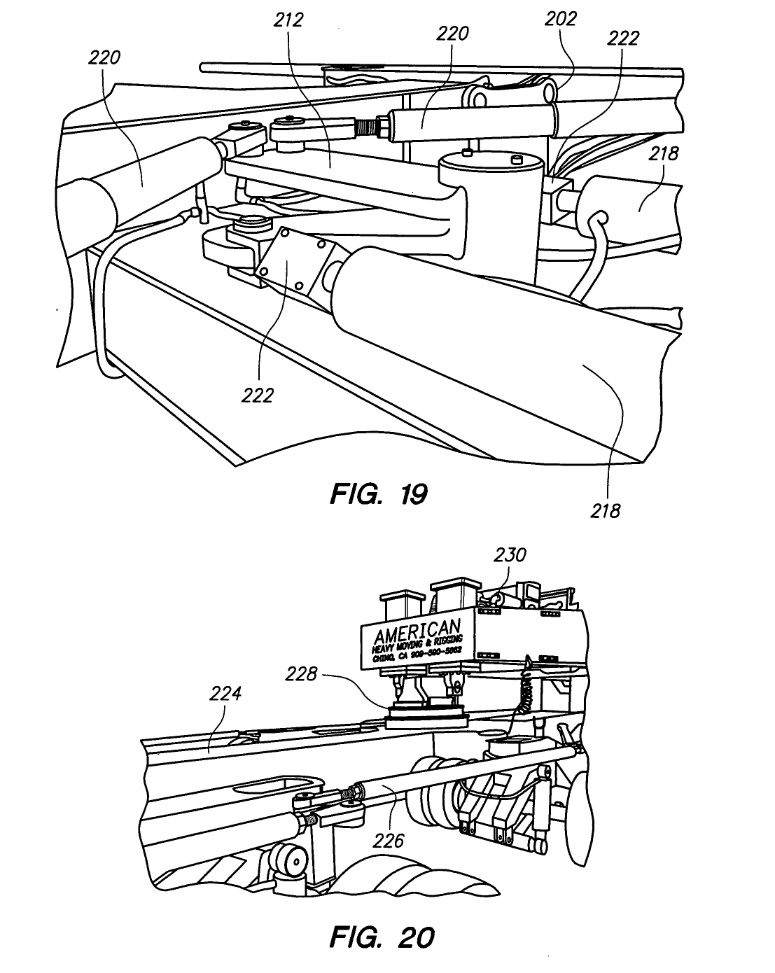

In particular, the hydraulic control unit 216 is controlled by the position of the draw bar 210. The position of the draw bar 210 opens and closes ports within the hydraulic control unit 216 for directing hydraulic oil to a set of pistons which in turn controls the steering of the forward module 202 in a push-pull manner to operate the V-shaped steering rods 220. The push-pull pistons 218 and V-shaped steering rods 220 serve to control the position of the axle and wheels as is shown in FIG. 19. Additionally, a pair of limiting blocks 222 cooperate with the push-pull pistons 218 to limit the travel and turning radius of the wheels of the forward module 202 to approximately 33-degrees. It is noted that the hydraulic control unit 216 is mounted parallel to the forward strut 214 so that the hydraulic control unit 216 is not damaged if the forward strut 214 malfunctions. Furthermore, the hydraulic control unit 216 is mounted at the forward position of the forward module 202 to respond quickly to signals from the changing position of the draw bar 210 for minimizing response lag time.

The transport vehicle 200 includes a central spine or beam 224 clearly shown in FIGS. 20 and 21. It is noted in FIG. 20 that the port and starboard side steering rods 226 are positioned below the surface of the central spine 224 so that the central spine 224 can be utilized to carry a payload. Additionally, a forward bearing 228 is positioned on the central spine 224. The central spine 224 in combination with the forward bearing 228 serves to provide structural support to the load bearing center module 204 as is clearly shown in FIG. 21. In particular, the forward bearing 228 which provides turning or rotational freedom and point loading to the load bearing center module 204 is supported by the central spine 224. Additionally, a diesel engine 230 shown in the superstructure of the center module 204 in FIG. 20 provides a constant power source to the automatic power steering subsystem 212.

The back end of forward module 202 and the front end of the load carrying center module 204 are each shown in FIG. 22. The hydraulic suspension system 20 as shown in earlier FIGS. 5-7 including the first and second arms 30, 32, the axle linkage member 38, and the pair of fluid activated cylinders 48 is clearly shown in FIG. 22. The hydraulic suspension system 20 includes two closed oil systems (i.e., port and starboard) between the four front and four rear wheels 35. The full stroke of each of the fluid activated cylinders 48 in the hydraulic suspension system 20 is eleven inches.

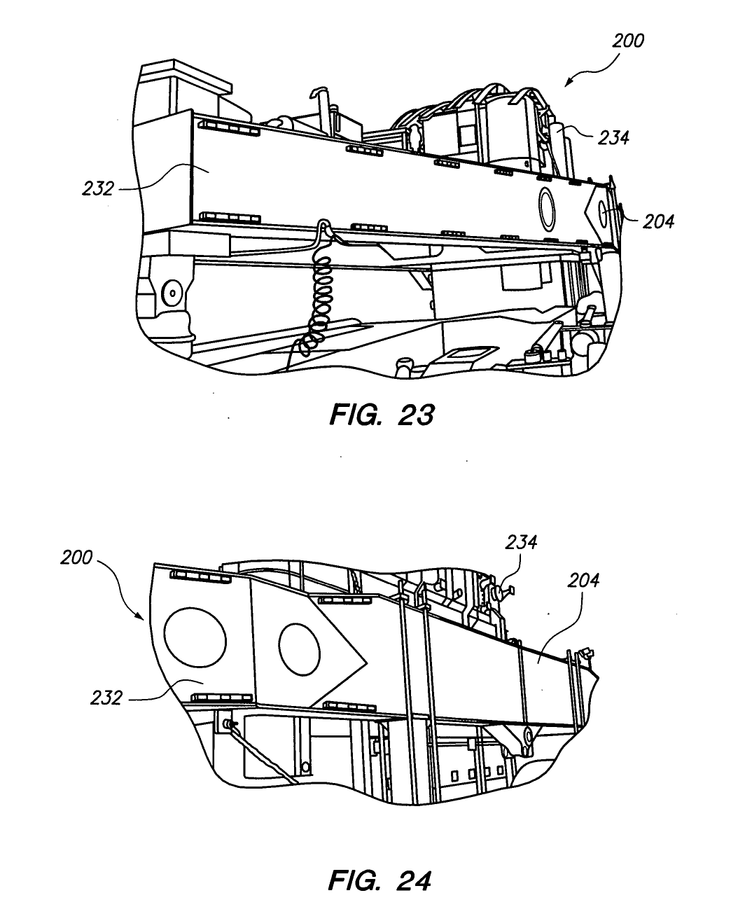

The center module 204 is shown in both FIGS. 23 and 24 and clearly shows the main load carrying beam 232. The massive payload 234 is carried by the main load carrying beam 232 of the center module 204. The load carrying capacity of the main load carrying beam 232 is a payload 234 of up to and including 500,000 lbs.

Notwithstanding, the heavy haul transport vehicle 200 can travel at speeds of 30 mph on a dual lane highway environment.

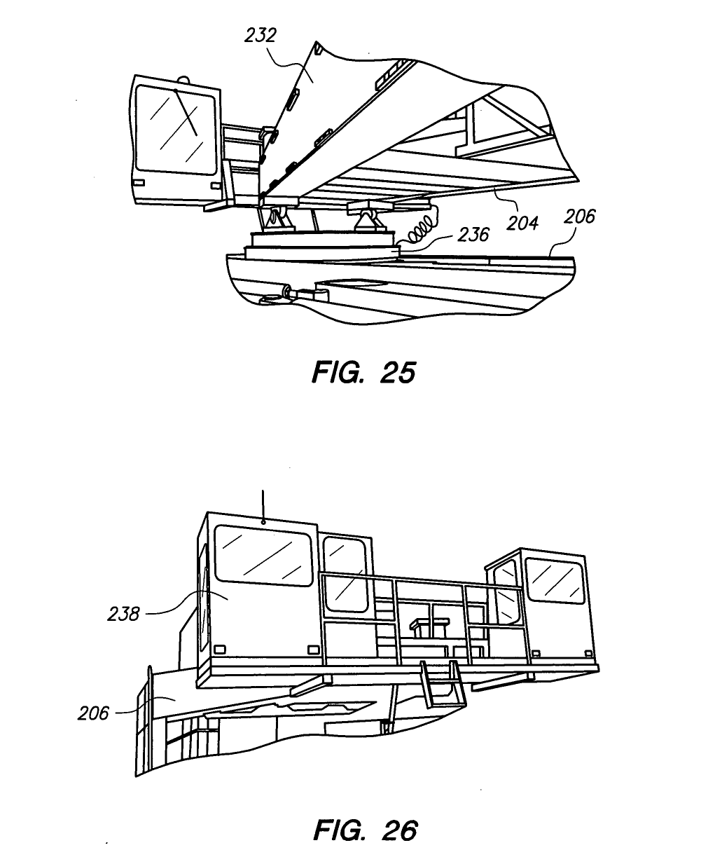

A rear bearing 236 is positioned on the rear module 206 as shown in FIG. 25. The rear bearing 236 is employed for point loading of the rear section of the center module 204, that is, the weight of the massive payload 234 applied to the main load carrying beam 232 is distributed across the rear module 206 by the rear bearing 236. Furthermore, the rear bearing 236 also provides turning or rotational freedom as well as point loading to the load bearing center module 204. Twin steering cabs 238 are positioned on the back end of the rear module 206 as shown in FIG. 26 and are employed to control and steer the rear module 206. It is noted that the controlling and steering of the rear module 206 is independent of the controlling and steering of the forward module 202. The operator (not shown) is typically seated in the rear steering cabs 238 to control and steer the rear module 206.

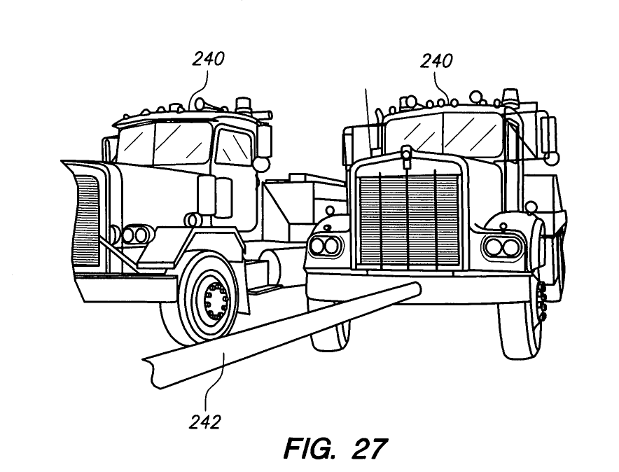

The second prime mover 240 is utilized to push the transport vehicle 200 from the rear side of the rear module 206 to promote forward movement of the transport vehicle 200. In the preferred embodiment shown in FIG. 27, the second prime mover 240 is shown as a pair of driver trucks or tractors equipped with driver push rods 242 to facilitate forward motion of the rear module 206. The pushing force associated with the driver push rods 242 in combination with the pulling force of the draw bar 210 serves to initiate movement of the multi-axle transport vehicle 200.

Thus, the present invention discloses a multi-axle transport vehicle 200 for hauling heavy loads including a plurality of modules in mechanical communication mounted on axles and wheels and being driven by a first prime mover 208 and a draw bar 210, the modules including forward, center and rear modules 202, 204 and 206, respectively, an automatic power steering unit 212 cooperating with the draw bar 210 and having a hydraulic control 216 unit and a plurality of push-pull pistons 218 and V-shaped steering rods 220 for controlling axle and wheel position, a central spine 224 formed on the forward module 202 and carrying a forward bearing 228 for providing structural support for a transported load mounted on the center module 204, a suspension system 20 including first and second arms 30, 32 attached to an axle linkage member 38 and cooperating with first and second fluid activated cylinders 48 attached to the modules for dynamically suspending the transported load, and a bearing positioned on the rear module 206 for providing structural support to the transported load.

The preferred embodiments of the invention described herein are exemplary and numerous modifications, variations, and rearrangements can be readily envisioned to achieve an equivalent result, all of which are intended to be embraced within the scope of the appended claims.

Accordingly,

What is claimed is:

1. A multi-axle transport vehicle for hauling heavy loads comprising:
a plurality of modules in mechanical communication, said modules being mounted on axles and wheels and being driven by a first prime mover and a tow bar, said modules comprising forward, center and rear modules;
an automatic steering unit cooperating with said tow bar, said steering unit including a hydraulic control unit and a plurality of push-pull pistons and steering rods for controlling axle and wheel position;
a central spine formed on said forward module and carrying a forward bearing for providing structural support for a transported load mounted on said center module;
a suspension system including first and second arms attached to an axle linkage member and cooperating with first and second fluid activated cylinders attached to said modules for dynamically suspending said transported load; and
a rear bearing positioned on said rear module for providing structural support to said transported load, said rear module being driven by a second prime mover.
